(19) United States
(12) Patent Application Publication
(10) Pub. No.: US 2008/0197282 A1
(43) Pub. Date: Aug. 21, 2008

(54) Scanning Transmission Charged Particle Beam Device

(75) Inventors: Yoshihiko Nakayama, Hitachinaka (JP); Isao Nagaoki, Hitachinaka (JP); Ryoichi Ishii, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Minato-ku (JP)

(21) Appl. No.: 12/031,754

(22) Filed: Feb. 15, 2008

(30) Foreign Application Priority Data
Feb. 16, 2007 (JP) 2007-036399

(51) Int. Cl. G01N 23/00

(52) U.S. Cl. 250/311; 250/306

(57) ABSTRACT

There is provided a scanning transmission charged particle beam device by which charged particles of a bright-field image and charged particles of a dark-field image may be clearly separated, and bright-field images and dark-field images with high accuracy may be obtained even in a state in which the scanning range of a charged particle beams on a sample is changed.

A deflecting coil is provided below a sample, and a charged particle detector for a dark-field image with an opening is provided below the deflecting coil. A charged particle detector for a bright-field image is provided below the above opening. By the deflecting coil below the sample, a charged particle beam for a bright-field image is configured to be synchronized with the scanning of a particle beam, and to be deflected in an opposite direction to the deflected direction of the particle beam. Thereby, a charged particles beam of a bright-field image passes through the opening of the charged particle detector for a dark-field image, and is detected by the charged particle detector for a bright-field image.

### BACKGROUND OF THE INVENTION

1. Field of the Invention

The present invention relates to a transmission charged particle beam device, and, more particularly, to a scanning transmission charged particle beam device for generating a transmission scanning image.

2. Description of the Related Art

Referring to FIG. 5A and FIG. 5B, there will be explained a method for obtaining a transmission scanning image (STEM image). When electrons 51 are irradiated and scanned on a sample 52, electrons of a bright-field image 53 and electrons of a dark-field image 54 are irradiated from the undersurface of the sample 52. The electrons of a bright-field image 53 are chiefly electrons which have transmitted the sample, and have a small scattering angle, and large energy. The electrons of a dark-field image 54 are chiefly electrons scattered in the sample, and have a large scattering angle and small energy.

When a bright-field STEM image is observed, an annular diaphragm 55 for a bright-field is arranged under a sample 52, and an electron detector for a bright-field image 56 is arranged thereunder as shown in FIG. 5A. Electrons of a dark-field image 54 among electrons from the sample 52 are intercepted by the diaphragm 55 for a bright-field, and the electrons of a bright-field image 53 pass trough a hole in the diaphragm 55 for a bright-field, and are detected by an electron detector for a bright-field image 56. On the other hand, a disc-type dark-field diaphragm 57 is arranged under a sample 52, and an electron detector for a dark-field image 58 is arranged thereunder as shown in FIG. 5B, when a dark-field STEM image is observed. Among electrons from the sample 52, electrons of a bright-field image 53 are intercepted by the disc-type dark-field diaphragm 57, and electrons of a dark-field image 54 pass through the periphery of the dark-field diaphragm 57 to be detected by the electron detector for a dark-field image 58.

Japanese Patent Publication No. 3776887 has disclosed a method for changing the scattering-angle range of transmission electrons to be detected by way of a configuration such that the position of a transmission electron detector may be changed. Moreover, Japanese Patent Publication No. 3776887 also has disclosed a method for securing an appropriate signal-to-noise ratio and a proper contrast by arranging a deflecting coil, a bright-field diaphragm, and an electron detector for a bright-field image under an electron detector for a dark-field image, and by leading transmission electrons to a diaphragm with an appropriate hole diameter through the deflecting coil.

Japanese Patent Application Laid-Open No. 2004-253369 has disclosed a method for separating transmission electrons (electrons of a bright-field image) from transmission scattering electrons (electrons of a dark-field image) by providing a transmission signal conversion member for emitting secondary electrons by collision with transmission electrons.

Generally, the discharging range of electrons of a bright-field image and that of electrons of a dark-field image are also changed when the scanning range of electron beams on a sample is changed. Thereby, the hole diameter of a bright-field diaphragm and the outside diameter of a dark-field diaphragm are required to be changed, corresponding to changes in the seaming range of electron beams, in order to clearly separate electrons of a bright-field image and electrons of a dark-field image. When the diameter of the diaphragm is not changed even under a state in which the scanning range of electron beams is changed, the electrons of a bright-field image and the electrons of a dark-field image are not sufficiently separated. Thereby, detection amount by an electron detector for a bright-field image, and that by an electron detector for a dark field image are reduced to cause resolution reduction in a bright-field image and that in a dark-field image. For example, when a STEM image with a low magnification is acquired, an enlarged diaphragm-diameter is required. In this case, a contrast and a S/N (signal to noise ratio) for a STEM image is reduced because non-separation between the electrons of a bright-field image and the electrons of a dark-field image becomes large.

According to conventional methods shown in FIG. 5A and FIG. 5B, a bright-field image and a dark-field image may not be obtained at the same time. When both a bright-field image and a dark-field image are obtained, a diaphragm is required to be exchanged.

### SUMMARY OF THE INVENTION

An object of the present invention is to provide a scanning transmission charged particle beam device by which charged particles of a bright-field image and charged particles of a dark-field image may be clearly separated, and bright-field images and dark-field images with high accuracy may be obtained even in a state in which a scanning range on a sample is changed.

According to the present invention, a deflecting coil is provided below a sample, and a signal detector for a dark-field image with an opening is provided below the deflecting coil. A signal detector for a bright-field image is provided below the above opening. By the deflecting coil below the sample, a charged particle beam of a bright-field image is configured to be synchronized with the scanning of a particle beam and to be deflected in an opposite direction to the deflected direction of the particle beam. Thereby, a charged particle beam of a bright field image passes through the opening of the signal detector for a dark-field image, and is detected by the signal detector for a bright-field image.

According to the present invention, the signal detector for a dark-field image has an effective detection region around the opening, and the region has a concentric configuration with the opening. Non-elastically scattered charged particles are detected by the effective detection region.

According to the present invention, charged particles of a bright-field image and charged particles of a dark-field image may be clearly separated, and bright-field images and dark-field images with high accuracy may be obtained even in a state in which the scanning range of charged particle beams on a sample is changed.

### BRIEF DESCRIPTION OF THE DRAWINGS

FIG. 1 is a view showing a configuration of an example of a scanning transmission electron microscope device according to the present invention;

FIG. 2 is a view explaining electrons of a dark-field image generated from a sample;

FIG. 3 is a view showing a configuration of another example of the scanning transmission electron microscope device according to the present invention;

FIG. 4A through FIG. 4C are views showing examples of non-elastically scattered electron detector provided in the scanning transmission electron microscope device according to the present invention; and

FIG. 5A and FIG. 5B are views showing states in which electrons of a bright-field image and electrons of a dark-field image are generated from a sample.

### DESCRIPTION OF REFERENCE NUMERALS

1: ELECTRON SOURCE
2: EXTRACTION ELECTRODE
3: ACCELERATING ELECTRODE
4: ELECTRON BEAM
5: FOCUSING LENS
6: ELECTRON BEAM DEFLECTING COIL
7: DEFLECTION FULCRUM
8: OBJECTIVE LENS
9: SAMPLE
10: TRANSMISSION ELECTRON DEFLECTING COIL
11: ELECTRONS OF A BRIGHT-FIELD IMAGE
12: ELECTRONS OF A DARK-FIELD IMAGE
12A: NON-ELASTICALLY SCATTERED ELECTRON
12B: ELASTICALLY SCATTERED ELECTRON
13: OPTICAL AXIS
14: FOCUSING POINT OF ELECTRONS OF A BRIGHT-FIELD IMAGE
15: ELECTRON DETECTOR FOP A DARK-FIELD IMAGE
15a: OPENING
16: ELECTRON DETECTOR OF A BRIGHT-FIELD IMAGE
17: NON-ELASTICALLY SCATTERED ELECTRON DETECTOR
17a: OPENING
18: SAMPLE VOLTAGE APPLICATION CIRCUIT
21: ELECTRON BEAM
22: SAMPLE
23: ELECTRONS OF A BRIGHT-FIELD IMAGE
24: ELECTRONS OF A DARK-FIELD IMAGE
24A: NON-ELASTICALLY SCATTERED ELECTRON
24B: ELASTICALLY SCATTERED ELECTRON
51: ELECTRON BEAM
52: SAMPLE
53: ELECTRONS OF A BRIGHT-FIELD IMAGE
54: ELECTRONS OF A DARK-FIELD IMAGE
55: DIAPHRAGM FOR BRIGHT-FIELD
56: ELECTRON DETECTOR OF A BRIGHT-FIELD IMAGE
57: DIAPHRAGM FOR DARK-FIELD
58: ELECTRON DETECTOR FOR A DARK-FIELD IMAGE
171: EFFECTIVE DETECTION REGION
172: MASK FOR ELECTRON INTERCEPTION

### DESCRIPTION OF THE PREFERRED EMBODIMENTS

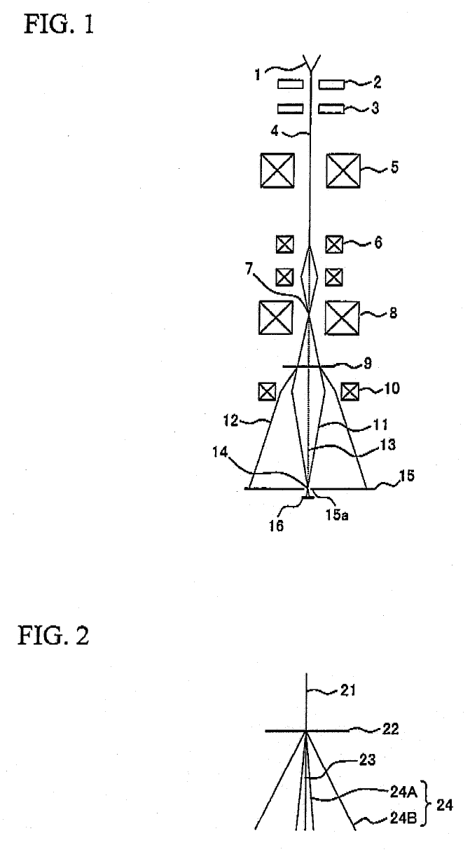

An example of a scanning transmission electron microscope according to the present invention will be explained referring to FIG. 1. The scanning transmission electron microscope in the present example has an electron source 1, an extraction electrode 2, an accelerating electrode 3, a focusing lens 5, a deflecting coil 6, and an objective lens 8. The scanning transmission electron microscope in the present example has a transmission electron deflecting coil 10 provided below a sample 9, an electron detector for a dark-field image 15, and an electron detector for a bright-field image 16. An opening 15a through which electrons of a bright-field image passes is provided in the electron detector for a dark-field image 15, and the electron detector for a bright-field image 16 is provided below the opening 15a.

Electron beams 4 are generated from the electron source 1 by the extraction electrode 2. The electron beam 4 is accelerated, for example, to about 30 keV by the accelerating electrode 3. The accelerated electron beam 4 is focused on an optical axis by the focusing lens 5, and is focused again by the objective lens 8 for irradiation on the sample 9. There is performed two-dimensional scanning of the electron bean) 4 on the sample 9 with a deflection fulcrum 7 as a fulcrum by the electron beam deflecting coil 6.

Electrons of a bright field image 11 and electrons of a dark field image 12 are irradiated from the undersurface of the sample 9. The electrons of a bright-field image 11 are chiefly electrons which have transmitted the sample, and have a small scattering angle, and large energy. The electrons of a dark field image 12 are chiefly electrons scattered in the sample, and have a large scattering angle and small energy.

The transmission electron deflecting coil 10 is arranged below the sample 9. By the transmission electron deflecting coil 10, electrons of a bright-field image 11 are configured to be synchronized with the electron beam deflecting coil 6 and to be deflected in an opposite direction to the deflected direction by the electron beam deflecting coil 6. The electrons of a bright-field image 11 are deflected by the transmission electron deflecting coil 10, and are always focused at a focusing point of electrons of a bright-field image 14 on the electron detector for a dark-field image 15. The focusing point of electrons of a bright-field image 14 may be on an optical axis 13. The electrons of a bright-field image 11 are focused to pass through the opening 15a in the electron detector for a dark-field image 15, and are irradiated onto the electron detector for a bright-field image 16. Thus, the present example has a configuration such that, even under a state in which an electron beam 4 is deflected by the electron beam deflecting coil 6, the electrons of a bright-field image 11 from the sample always pass through the opening 15a in the electron detector for a dark-field image 15 to be detected by the electron detector for a bright-field image 16.

On the other hand, the electrons of a dark-field image 12 are detected by the electron detector for a dark-field image 15. All the electrons of a bright-field image 11 are led to the opening 15a in the electron detector for a dark-field image 15 by the transmission electron deflecting coil 10. Accordingly, only the electrons of a dark-field image 12 are irradiated onto the electron detector for a dark-field image 15.

The scattering angle and the energy of the electrons of a dark-field image 12 and those of the electrons of a bright-field image 11 are different from each other. Even when the electrons of a bright-field image 11 are deflected by the transmission electron deflecting coil 10, the electrons of a dark-field image 12 are not deflected in a manner similar to that of the electrons of a bright-field image 11. The electrons of a dark-field image 12 do not pass through the opening 15a of the electron detector for a dark-field image 15. On the other hand, almost all the electrons of a dark-field image 12 may be detected when the effective detection region of the electron detector for a dark-field image 15 is set enough large. Thus, the electrons of a dark-field image 12 and the electrons of a bright-field image 11 may be clearly separated in the present example.

Even when the scanning region of the electron beam 4 on the sample is changed, the deflection by the transmission electron deflecting coil 10 is controlled, corresponding to the changes, according to the present invention. Accordingly, the electrons of a dark-field image 12 and the electrons of a bright-field image 11 may be completely separated even when the scanning region of the electron beam 4 is changed. Furthermore, a bright-field image may be obtained by the electron detector for a bright-field image 16, and, at the same time, a dark-field image may be obtained by the electron detector for a dark-field image 15 according to the present invention. That is, the bright-field image and the dark-field image may be obtained at the same time without exchange of the detector.

The diameter of the opening 15a in the electron detector for a dark-field image 15 is required to be determined in such a way that the focused electrons of a bright-field image 11 may pass through the opening 15a, but the diameter is preferably as small as possible. However, too small diameter causes difficult processing. The diameter of the opening 15a is, preferably, smaller than 5 mm, and larger than 0.01 mm, and, more preferably, 1 mm or less.

In the present example, the effective detection region of the electron detector for a bright-field image 16 may be slightly larger than the diameter of the opening 15a. For example, when the diameter of the opening 15a is 1 mm, the diameter of the effective detection region for the electron detector for a bright-field image 16 may be 1.1 mm through 2 mm.

The configuration of the signal detection portion in the electron detector for a dark-field image 15, and that of the signal detection portion in the electron detector for a bright-field image 16 are well-known. For example, a CCD (charge coupled device), or a scintillator may be used for the signal detection portion.

Though there has been explained here a case in which the magnetic field by the transmission electron deflecting coil 10 is used, a focusing lens, instead of the transmission electron deflecting coil 10 may be used. That is, the electrons of a bright-field image are not deflected, but are focused. In the case of a focusing lens, stronger excitation is required in comparison with that of a deflecting coil. Thereby, it is difficult to focus the electrons of a bright-field image when the scanning range of electron beams is large. Then, it is required to limit the scanning range of the electron beam. Alternatively, the converging efficiency may be increased by a configuration such that there are provided two or more stages of focusing lenses.

The electrons of a dark-field image will be explained in detail referring to FIG. 2. When an electron beam 21 is irradiated onto one point on the upper surface of a sample 22, electrons of a bright-field image 23 and electrons of a dark-field image 24 are generated from the undersurface of the sample 22. The electrons of a bright-field image 23 are electrons which are hardly scattered within the sample, and are emitted in the same direction as that of the irradiation electron beam with little extension. The electrons of a dark-field image 24 are electrons scattered within the sample, and are irradiated, extending at a certain scattering angle to an incident electron beam.

The electrons of a dark-field image 24 includes a non-elastically scattered electron 24A which is non-elastically scattered within the sample, and an elastically scattered electron 24B which is elastically scattered within the sample. The scattering angle of the non-elastically scattered electron 24A is about several ten mrad, and the energy is about 90% of that of the irradiation electron beam. On the other hand, the scattering angle of the elastically scattered electron 24B is about several 100 mrad, and the energy is equal to that of an irradiation electron beam. Here, FIG. 2 schematically shows the electrons of a bright-field image 23, the electrons of a dark-field image 24, the non-elastically scattered electron 24A, and the elastically scattered electron 24B. Actually, these electrons are continuously distributed to the scattering angle.

The energy of the non-elastically scattered electron 24A depends on the scattering angle. A larger scattering angle of the non-elastically scattered electron 24A causes the energy to become smaller. Accordingly, a non-elastically scattered electron of specific energy may be detected by selectively detecting a non-elastically scattered electron with a specific scattering angle. As described above, useful information for a structural analysis of a sample is obtained by detecting the non-elastically scattered electron of specific energy, and by obtaining a transmission electron image. Hereinafter, there will be explained an example of a non-elastically scattered electron detector, by which a non-elastically scattered electron with a specific energy is detected.

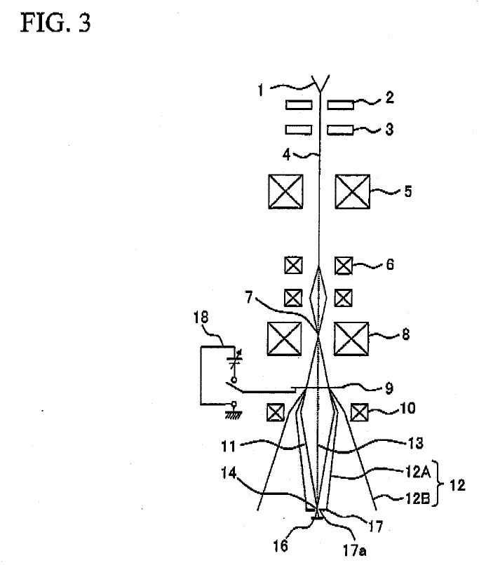

Other examples of the scanning transmission electron microscope according to the present invention will be explained referring to FIG. 3. A different point between the scanning transmission electron microscope according to the present example and the scanning transmission electron microscope shown in FIG. 1 is that there is provided a non-elastically scattered electron detector 17, instead of an electron detector for a dark-field image. Here, the non-elastically scattered electron detector 17 in the present example will be explained. The non-elastically scattered electron detector 17 in the present example has a configuration such that a non-elastically scattered electron of specific energy is detected. That is, the non-elastically scattered electron detector 17 according to the present example is configured to detect a non-elastically scattered electron of a specific scattering angle. An opening 17a for passing electrons of a bright-field image is provided in the non-elastically scattered electron detector 17 according to the present example, and the electron detector for a bright-field image 16 is provided below the opening 17a. Only a non-elastically scattered electron 12A among the electrons of a dark-field image 12 is detected by the non-elastically scattered electron detector 17. But an elastically scattered electron 12B is not detected by the non-elastically scattered electron detector 17. A sample voltage application circuit 18 will be explained later.

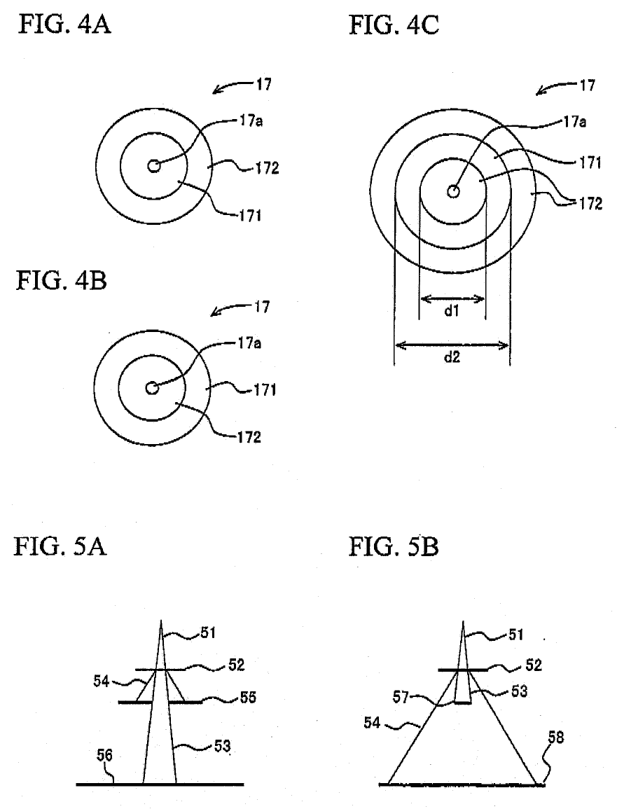

The detailed structure of the non-elastically scattered electron detector 17 will be explained referring to FIG. 4A through FIG. 4C. In the non-elastically scattered electron detector 17 shown in FIG. 4A, an effective detection region 171 is provided around the opening 17a for passing electrons of a bright-field image. And a concentric and annular mask 172 for electron interception is provided outside the region 171. The mask 172 for electron interception functions in such a way that electron beams are intercepted, and may include, for example, a thin metal plate. Among non-elastically scattered electrons 12A, electrons with a comparatively small scattering angle are irradiated onto the effective detection region 171, and electrons with a comparatively large scattering angle are irradiated onto the mask 172 for electron interception. The smaller scattering angle causes the energy of non-elastically scattered electrons to become larger. Accordingly, electrons with a comparatively large energy, among non-elastically scattered electrons 12A, are irradiated onto the effective detection region 171, and electrons with a comparatively small energy are irradiated onto the mask 172 for electron interception. Thus, the non-elastically scattered electron detector 17 according to the present example may detect electrons with a comparatively large energy among non-elastically scattered electrons 12A.

In the non-elastically scattered electron detector 17 shown in FIG. 4B, the mask 172 for electron interception is provided around the opening 17a for passing electrons of a bright-field image. And a concentric and annular effective-detection region 171 is provided outside the region 172. Among non-elastically scattered electrons 12A, electrons with a comparatively large scattering angle are irradiated onto the effective detection region 171, and electrons with a comparatively small scattering angle are irradiated onto the mask 172 for electron interception. Accordingly, electrons with a comparatively small energy, among non-elastically scattered electrons 12A, are irradiated onto the effective detection region 171, and electrons with a comparatively large energy are irradiated onto the mask 172 for electron interception. As described above, the non-elastically scattered electron detector 17 according to the present example may detect electrons with a comparatively small energy among non-elastically scattered electrons 12A.

As shown in FIG. 4C, an average (d1+d2)/2 of the inside diameter d1 and the outside diameter d2 of a ring as the effective detection region 171 is defined as the diameter of the effective detection region 171, and a difference (d2−d1) between the outside diameter d2 and the inside diameter d1 is defined as the width of the effective detection region 171. A non-elastically scattered electron with a desired energy may be detected by changing the diameter and the width of the effective detection region 171.

Non-elastically scattered electrons with a broader range of energies may be detected, for example, by increasing the width of the effective detection region 171. On the other hand, non-elastically scattered electrons with a narrower range of energies may be detected by reducing the width of the effective detection region 171. That is, it may be said that the width of the effective detection region 171 is corresponding to the energy width of detected non-elastically scattered electrons. Accordingly, the width of the effective detection region 171 is acceptably reduced when non-elastically scattered electrons with an extremely-narrow specific range of energies are detected.

On the other hand, non-elastically scattered electrons with larger energies may be detected when the diameter of the effective detection region 171 is reduced. On the other hand, non-elastically scattered electrons with smaller energies may be detected when the diameter of the effective detection region 171 is increased. That is, it may be said that the diameter of the effective detection region 171 is corresponding to the size of the energies of the non-elastically scattered electrons to be detected. Accordingly, the diameter and the width of the effective detection region 171 are acceptably reduced when non-elastically scattered electrons with an extremely large energy are detected.

The scattering angle of non-elastically scattered electrons depends on the structure, the composition, and the thickness of a sample, and the like, and, moreover, on the energy of the irradiation electrons. Accordingly, a voltage (acceleration voltage) applied to the accelerating electrode 3 is adjusted, and, thereby, the scattering angle may be adjusted by adjusting the energy of the irradiation electrons. For example, the voltage applied to the accelerating electrode 3 may be configured to be changed by about 1 V. In the examples shown in FIG. 4A through FIG. 4C, the non-elastically scattered electron detector 17 is required to be exchanged when the energy of non-elastically scattered electron to be detected is changed. However, the energy of a non-elastically scattered electron may be adjusted without exchange of the non-elastically scattered electron detector 17 by controlling the scattering angle of non-elastically scattered electrons.

FIG. 3 is referred again. The sample voltage application circuit 18 is provided in the example shown in FIG. 3. The potential of the sample 9 is usually at an earth level, but a negative voltage is applied to the sample 9 by the sample voltage application circuit 18. When electrons irradiated to the sample 9 approaches the sample, the electrons are decelerated by a negative electric field generated by the negative voltage applied to the sample 9. When the energy of the electrons irradiated to the sample 9 is decreased, the energy of non-elastically scattered electrons emitted from the sample is also reduced. Thus, the energy of non-elastically scattered electrons to be detected may be adjusted without exchanging the non-elastically scattered electron detector 17 by applying a negative voltage to the sample 9.

In order to keep the resolution of the sample, a negative voltage is acceptably applied to the sample in a state in which an acceleration voltage is kept high. Here, a positive voltage may be applied to the sample. Thereby, the energy of irradiation electrons is increased, and the energy of non-elastically scattered electrons is increased.

Examples according to the present invention have been explained as described above, but it will be easily appreciated by persons skilled in the art that the present invention is not limited to the above-described examples, and various modifications may be made within the scope of the invention described in claims.

Examples of scanning transmission electron microscopes have been explained in FIG. 1 and FIG. 3. The present invention may be applied not only to a scanning transmission electron microscope, but also to a scanning transmission charged particle beam device irradiating charged particles to a sample.

The present invention may be applied not only to a scanning transmission electron microscope detecting transmission scanning electrons, but also to a scanning transmission charged particle beam device irradiating charged particles to a sample.

What is claimed is:

1. A scanning transmission charged particle beam device, comprising:
a focusing lens for converging charged particle beams from a charged particle source;
a first deflecting lens for scanning a charged particle beam on a sample;
an objective lens for focusing a charged particle beam on said sample;
a second deflecting lens which is arranged below said sample, and for deflecting a charged particle beam of a bright-field image from said sample; and
a charged particle detector for a bright-field image for detecting said charged particles of a bright-field image deflected by said second deflecting lens, wherein
said second deflecting lens deflects a charged particle beam of a bright-field image from said sample in synchronization with scanning by said first deflecting lens and in an opposite direction to the deflection by said first deflecting lens, and focuses said charged particle beam of a bright-field image onto said charged particle detector for a bright-field image.

2. The scanning transmission charged particle beam device as claimed in claim 1, wherein
a charged particle detector for a dark-field image for detecting charged particles of a dark-field image is provided below said second deflecting lens,
said charged particle detector for a dark-field image has an opening through which a charged particle beam of a bright-field image passes, wherein said charged particle beam of a bright-field image has been deflected and focused by said second deflecting lens, and
said charged particle detector for a bright-field image is provided below said opening.

3. The scanning transmission charged particle beam device as claimed in claim 2, wherein
said charged particle detector for a dark-field image has an effective detection region for detecting only non-elastically scattered charged particle among charged particles of a dark-field image, and
said effective detection region is provided outside said opening, and has a concentric configuration with said opening.

4. The scanning transmission charged particle beam device as claimed in claim 3, wherein
a mask for intercepting elastically scattered charged particles is provided in a region except said effective detection region of said charged particle detector for a dark-field image.

5. The scanning transmission charged particle beam device as claimed in claim 3, wherein
a non-elastically scattered charged particle with a desired energy is detected by setting the diameter and the width of said effective detection region at a desired value, when an average (d1+d2)/2 of the inside diameter d1 and the outside diameter d2 of said effective detection region is defined as the diameter of said effective detection region and a difference (d2−d1) between the outside diameter d2 and the inside diameter d1 is defined as the width of said effective detection region.

6. The scanning transmission charged particle beam device as claimed in claim 3, wherein
a voltage application circuit for applying a positive or negative voltage to a sample is provided, and non-elastically scattered charged particles irradiated to said effective detection region are adjusted by controlling a voltage applied to a sample through said voltage application circuit.

7. The scanning transmission charged particle beam device as claimed in claim 3, wherein
an accelerating circuit for accelerating and decelerating a charged particle beam is provided, and non-elastically scattered charged particles irradiated onto said effective detection region are adjusted by accelerating or decelerating a charged particle beam by said accelerating circuit.

8. The scanning transmission charged particle beam device as claimed in claim 1,
said charged particle beam is an electron beam, and is configured as a scanning transmission electron microscope device.

9. A scanning transmission charged particle beam device, comprising:
a first focusing lens for converging a charged particle beam from a charged particle source;
a deflecting lens for scanning a charged particle beam on a sample;
an objective lens for focusing a charged particle beam on said sample;
a second focusing lens which is arranged below said sample, and for focusing a charged particle beam of a bright-field image from said sample; and
a charged particle detector for a bright-field image for detecting a charged particle beam of a bright-field image focused by said second focusing lens.

10. The scanning transmission charged particle beam device as claimed in claim 9, wherein
a charged particle detector for a dark-field image for detecting charged particles of a dark-field image from a sample is provided below said second focusing lens,
said charged particle detector for a dark-field image has an opening through which a charged particle beam of a bright-field image focused by said second focusing lens pass, and
said charged particle detector for a bright-field image is provided below said opening.

11. A scanning transmission charged particle beam device as claimed in claim 9,
said charged particle beam is an electron beam, and is formed as a scanning transmission electron microscope device.

12. A method for controlling a scanning transmission charged particle beam device, comprising the steps of:
converging a charged particle beam from a charged particle source by a focusing lens;
scanning said charged particle beam on a sample by a first deflecting lens;
focusing said charged particle beam on said sample by an objective lens;
deflecting a charged particle beam of a bright-field image from said sample by a second deflecting lens in synchronization with scanning by said first deflecting lens and in an opposite direction to the deflection by said first deflecting lens; and
detecting charged particles of a bright-field image deflected by said second deflecting lens using a charged particle detector for a bright-field image.

13. The method for controlling a scanning transmission charged particle beam device as claimed in claim 12, including steps of:
providing a charged particle detector for a dark-field image below said second deflecting lens, said charged particle detector for a dark-field image detecting charged particles of a dark-field image from a sample, and having an opening through which a charged particle beam of a bright-field image passes, wherein said charged particle beam of a bright-field image has been deflected and focused by said second deflecting lens; and
arranging said charged particle detector for a bright-field image below said opening of said charged particle detector for a dark-field image.

14. The method for controlling a scanning transmission charged particle beam device as claimed in claim 13, wherein
said charged particle detector for a dark-field image has an effective detection region for detecting only non-elastically scattered charged particles among charged particles of a dark-field image, and
said effective detection region is provided outside said opening, and has a concentric configuration with said opening.

15. The method for controlling a scanning transmission charged particle beam device as claimed in claim 14, comprising a step of
applying a voltage to a sample in order to adjust non-elastically scattered charged particle irradiated onto said effective detection region.

16. The method for controlling a scanning transmission charged particle beam device as claimed in claim 14, comprising a step of
accelerating, or decelerating a charged particle beam in order to adjust non-elastically scattered charged particles irradiated onto said effective detection region.
